(19) United States
(12) Patent Application Publication
(10) Pub. No.: US 2003/0042643 A1
(43) Pub. Date: Mar. 6, 2003

(54) Process for molding laminate

(76) Inventor: Douglas L. Lammon, White Pigeon, MI (US)

Correspondence Address: FLYNN, THIEL, BOUTELL & TANIS, P.C., 2026 Rambling Road, Kalamazoo, MI, 49008-1699, US

(21) Appl. No.: 09/941,015

(22) Filed: Aug. 28, 2001

(51) Int. Cl. B29C 44/06

(52) U.S. Cl. 264/46.4; 264/255; 425/112; 425/450.1; 425/4 R

(57) ABSTRACT

A molding process and apparatus which improves on and simplifies the manufacturing apparatus for forming of laminated plastic parts. There is provided a main press having upper and lower mold parts which define a mold cavity corresponding to the laminated part. The upper mold part is movable into an open booking position so as to cooperate with an opposed injection molding tool associated with a partial injection molding press for injection molding of a backing layer therebetween. A thin skin can be formed in the open lower mold half of the main press. A quantity of foamable urethane is deposited in the open lower mold half over the skin. The upper mold half is then moved into closed position with the lower mold half, and the urethane reacts to fill the cavity and join to the opposed backing layer and skin to create the laminated part.

### FIELD OF THE INVENTION

This invention relates to a process and apparatus for the manufacture of a laminated member constructed of multiple layers of plastic materials.

### BACKGROUND OF THE INVENTION

Many laminated plastic parts are utilized in vehicles and the like, and such parts frequently employ at least three layers which are secured together, often involving molding and/or heat forming steps, so that the layers effectively create an integral sandwich. Such parts, such as instrument and door panels for vehicles, often involve a backing or substrate panel on one side, a thin skin on the other side, and an intermediate layer of plastic foam disposed between and generally adhesively joined to the outer layers. All of the layers are traditionally of plastics, and are typically formed in suitable molds, with some of the layers being formed in one mold and then transferred to a second mold so as to permit forming of the laminate. For example, it is traditional to form the substrate in an injection molding press, with the preformed substrate then being transferred to a press mold in which the skin has already been formed by means of spraying or the like, whereupon the press mold then has urethane poured therein between the substrate and the skin, whereby closure of the mold permits curing and foaming of the urethane so as to create a foamed layer disposed intermediate and connected to the substrate and skin.

With the widely known and utilized technique for forming laminates as summarized above, particularly for forming vehicle panels, the number of molds required, such as the provision of a separate injection mold for the substrate and a separate press mold for creating the laminate, and the additional handling steps required for removing and transferring the substrate from the injection mold to the press mold, necessarily results in the overall apparatus and forming system being more complex and less efficient than desired.

It is an object of this invention to provide an improved molding process and apparatus which improves on and simplifies the manufacturing apparatus and the manufacturing process associated therewith so as to permit forming of laminated plastic parts, particularly parts such as vehicle instrument and door panels, which parts employ at least three layers of plastics disposed in an overlying laminated relationship to permit creation of a finished part having the desired shape, size and thickness.

In the improved process and apparatus of the present invention, there is provided a main press having a tool defined by upper and lower mold parts which, when closed, cooperate to define a mold cavity which corresponds to the overall laminated part being produced. The upper mold part of the press is movable into an open booking position so as to cooperate with an opposed injection molding tool associated with a partial injection molding press. With the upper mold half of the main press positioned for cooperation with the mold half associated with the injection press, the substrate can be formed therebetween and, substantially simultaneous therewith, a thin skin can be formed in the open lower mold half of the main press. After forming of the substrate in the tool defined by the upper mold half and the injection mold tool, the upper mold half bearing the substrate is separated from the injection mold tool and is moved into a closed relationship with the lower mold tool. Prior to the latter, however, a material supply robot pours a predefined quantity of material, typically foamable urethane, over the skin formed in the open lower mold half. Thereafter the upper mold half is moved into closed position with the lower mold half so that the foamable urethane is contained in the cavity defined between the substrate layer and the skin. The urethane undergoes its reaction process so as to fill the cavity and join to the opposed substrate and skin layers to create the desired laminated part. The upper mold tool of the main press is then opened to permit removal of the laminated part.

Other objects and purposes of the invention will be apparent to persons familiar with constructions of this general type upon reading the following specification and inspecting the accompanying drawings.

### BRIEF DESCRIPTION OF THE DRAWINGS

FIG. 1 is a fragmentary sectional view which diagrammatically illustrates a three-layer laminate constructed according to the process and apparatus of the present invention.

FIG. 2 is a diagrammatic elevational view which illustrates the overall forming system of the present invention and which illustrates both the main press and the injection press in the open position.

FIG. 3 is a view similar to FIG. 2 but illustrates the injection press in a closed position.

FIG. 4 illustrates the main press in the open position after separation of the upper mold tool from the injection press.

FIG. 5 illustrates the main press in the closed position.

FIG. 6 illustrates the main press in the open position so as to permit removal of the laminate from the lower mold tool, prior to initiating a new part forming cycle.

FIGS. 7-9 are elevational views of the main molding press which respectively correspond to the main molding press as depicted in FIGS. 4-6, but which illustrate the construction of the main molding press with greater clarity.

Certain terminology will be used in the following description for convenience and reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from respectively the geometric center of the system and designated parts thereof. Said terminology will include the words specifically mentioned, derivatives thereof, and words of similar import.

### DETAILED DESCRIPTION

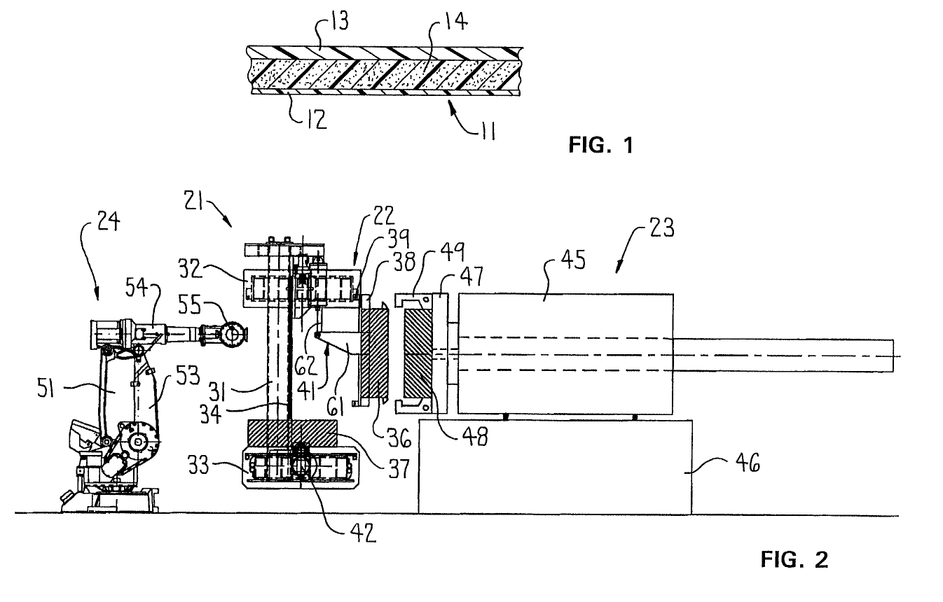

Referring to FIG. 1, there is diagrammatically illustrated, in cross section, a laminated part or panel 11 which can be economically constructed by means of the process and apparatus of the present invention. The part 11 is a three-layer laminated part having an outer layer 12 on one side thereof, which layer functions as a thin exterior skin and is defined by a thin flexible sheetlike structure which is of a plastics material, such as vinyl or urethane. The laminated part 11 also includes a further outer layer 13 on the other side thereof, the latter being defined by a backing panel or substrate which is typically injection molded of a plastics material, typically PVC, polyethylene, or other suitable plastics. The outer layers 12 and 13 in turn confine an intermediate layer 14 therebetween, the latter being of a foamed plastics material, typically urethane, with the intermediate foamed layer 14 typically being secured to and between the outer layers 12 and 13, either as a result of the forming process as described hereinafter, or by means of adhesive if required.

The three-layer laminated part 11 hence can be formed, as described hereinafter, so as to have the desired size and three dimensional contours, which size and contours can result in variations with respect to the shape and thickness of some of the layers, specifically the substrate layer 13 and the foam layer 14, so as to result in an integral one-piece structure. A laminated part having these constructional features is particularly desirable for many uses, such as for door panels and instrument panels of vehicles.

A laminated part having the overall constructional features illustrated by FIG. 1 is well known, and the apparatus and process of the present invention is believed to permit mass production of such parts in a more efficient manner while requiring a simplified apparatus for carrying out the forming process.

Referring to FIG. 2, there is diagrammatically illustrated an improved molding system 21 according to the present invention for permitting efficient forming of a laminated plastic part, such as a three-layer part as illustrated in FIG. 1.

The molding system 21 includes a main molding press 22 which is positionable for cooperation with an injection molding arrangement 23, the latter being a partial injection molding press. A material supply arrangement 24, typically one or more robotic devices, is positioned for cooperation with the main molding press 22 for supplying plastics material thereto.

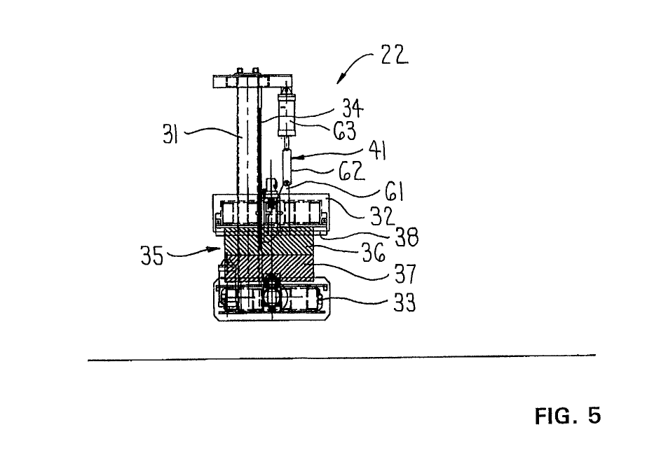

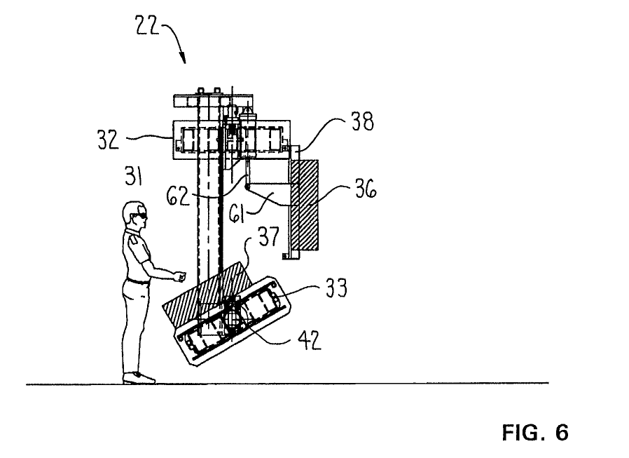

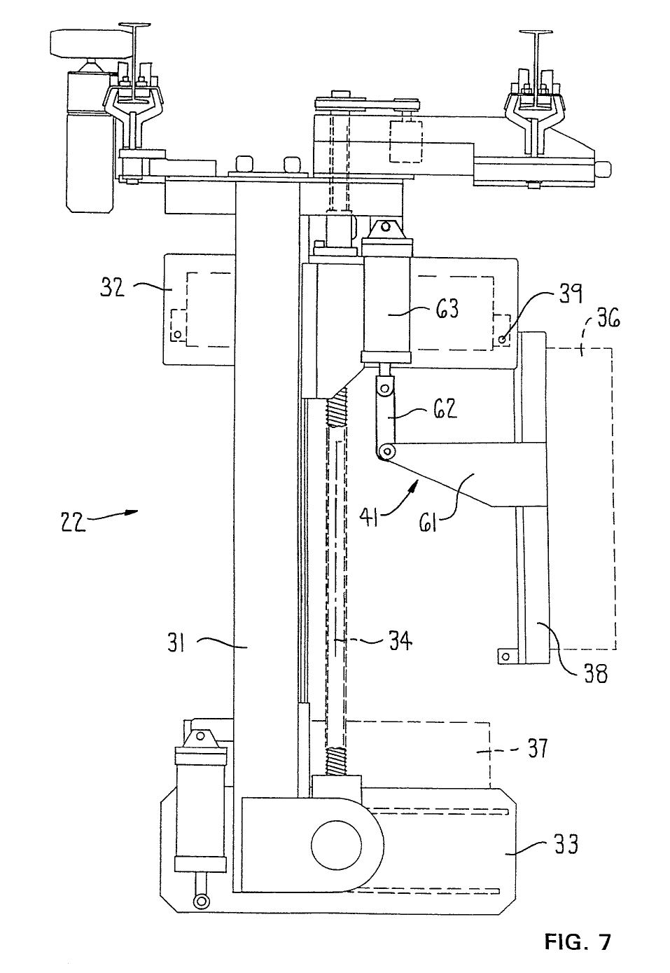

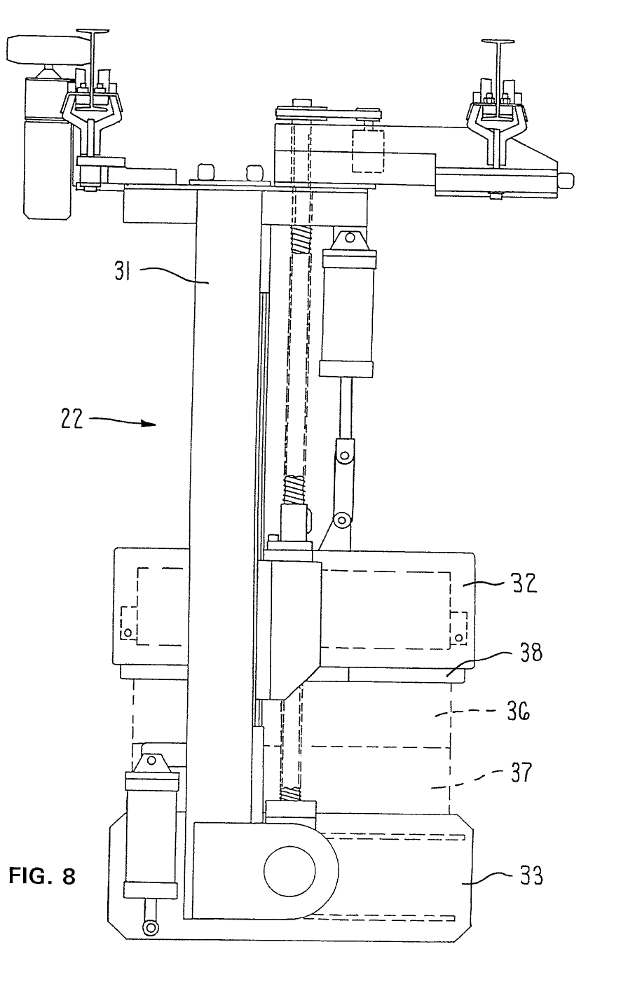

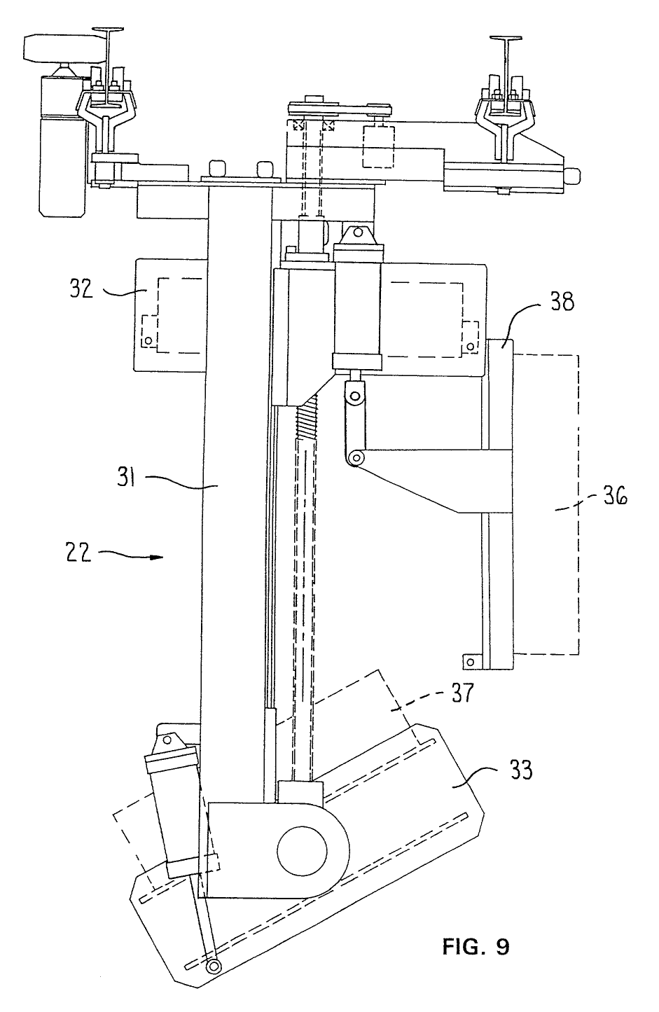

Considering first the main molding press 22, it includes a generally upright frame 31 which mounts thereon vertically opposed top and bottom platens 32 and 33 which are movable vertically toward and away from one another by means of a drive device which includes vertically elongate drive screws 34 mounted on the frame and cooperable with the movable platen. In the illustrated and preferred embodiment the top platen 32 cooperates with the drive screws so as to be vertically movable relative to the frame between the raised open position illustrated by FIGS. 2-4, and the lowered closed position illustrated by FIG. 5. The lower platen 33 may be stationarily positioned relative to the frame 31 or, as in the illustrated embodiment, may be coupled to the frame 31 by a horizontal hinge or pivot structure 42 so that the lower platen can be swung into a booking position as illustrated by FIG. 6 to facilitate access to the lower mold tool, such as for removal of the molded part. A suitable drive, such as a pressure cylinder, can be coupled between the frame 31 and lower platen 33 for effecting swinging of the lower platen between its normal position (FIG. 2) and the booked position (FIG. 6).

The top and bottom platens 32-33 mount thereon a molding tool 35 which is defined by a top tool or mold part 36 which is mounted to the top platen 32, and a bottom tool or mold part 37 which is secured to the top of the lower platen 33. The mold parts or halves 36-37 are positioned in vertically aligned and opposed relationship and define thereon opposed contoured mold surfaces which, when the mold halves 36-37 are vertically engaged and clamped together, define a mold cavity therebetween which is sized and configured to define the desired laminated part 11 which is to be formed.

The top platen 32, on the underside thereof, is provided with a booking plate 38 to which the top mold part 36 is secured, and this booking plate 38 in turn is joined along one edge thereof to the top platen 32 by a generally horizontally extending hinge or pivot structure 39. The opposite edge of the booking plate 38 has a latch 43 associated therewith, which latch cooperates with a mating latch part provided on the upper platen 32 to secure the booking plate 38, and the top mold part mounted thereon, in vertically aligned positional relationship with the bottom mold part 37.

The booking plate 38 is additionally interconnected to the top platen 32 by means of a booking linkage 41 which effects swinging movement of the booking plate 38 (and of the top mold part 36 mounted thereon) from the sidewardly oriented booking position illustrated in FIG. 2 when the upper platen 32 is in its raised position, and a horizontally oriented position wherein the booking plate 38 is positioned under and latched to the top platen 32 when the latter has moved vertically downwardly to a position wherein the upper mold part 36 is positioned close to but slightly above the lower mold part 37, in which position slight additional downward movement of the upper platen 32 effects closure of the mold parts 36-37. Thus, during downward vertical movement of upper platen 32 from the position illustrated by FIG. 2, the booking linkage 41 causes a corresponding inward swinging of the booking plate 38 about the hinge 39 (clockwise about hinge 39 in FIG. 2) until the booking plate 38 is horizontally oriented directly under and is latchingly engaged to the top platen 32. During opening or upward movement of the top platen 32, the booking plate 38 is unlatched from the top platen, and the booking linkage 41 causes reverse sideward swinging of the booking plate 38 back into the sideward orientation illustrated in FIG. 2.

The booking linkage 41, in the illustrated variation, includes an arm 61 which is fixed to and projects upwardly from the booking plate 38 in spaced relation from the hinge 39, which arm at its outer end is hingedly coupled to one end of an elongate link 62. This link 62 at its other end is hingedly coupled to one end of a piston rod which slidably projects outwardly from a spring unit 63, such as a pressure cylinder, which spring unit has its other end hingedly supported from the frame 31.

The structure of the main molding press 22, as well as an operational description thereof is described in detail in U.S. Pat. No. 6,206,676 B1 owned by the Assignee hereof, and the disclosure of this '676 patent is in its entirety incorporated herein by reference.

Considering now the injection molding apparatus 23, it includes an injector barrel 44 mounted on a platen carriage 45 which is movably mounted on a suitable base or frame 46, with the platen carriage 45 being linearly movable, such as horizontally movable, by an appropriate drive unit such as a pressure cylinder (not shown) coupled thereto. The injector barrel 44 is associated with conventional injection molding equipment (not shown) such as used for preparing and supplying synthetic plastic to the barrel for injection therefrom. The platen carriage 45 mounts on one end thereof a support platen 47 which is oriented generally vertically so as to face sidewardly, and the exposed face of the platen 47 mounts thereon one-half of an injection molding tool, namely the tool or mold part 48.

The injection mold part 48 as fixed to the platen 47 is adapted to cooperate with the upper mold part 36 as mounted on the booking plate 38 of the main molding press 22 when the booking plate 38 and the mold part 36 mounted thereon are in the sidewardly-oriented booking position illustrated by FIG. 2. In this latter position, the mold parts 36 and 48 are disposed in horizontally opposed and aligned relationship but are spaced a slight distance apart. The platen carriage 45 is then moved leftwardly in FIG. 2 to cause the mold part 48 to engage and effect closure with the mold part 36, whereupon appropriate latches or clamping devices, as diagrammatically illustrated at 49, are engaged to securely hold the mold parts 36 and 48 in closed engaged position. In this closed engaged relationship, the mold parts 36 and 48 define a tool having an internal mold cavity which has a shape and configuration corresponding to the substrate or backing panel 13, with the exposed surface of this substrate when incorporated into the laminated panel 11 being defined on the upper mold part 36. The injector barrel 44 has a discharge orifice which communicates with the mold cavity defined between the engaged mold parts 36 and 48 so as to permit injection of a suitable plastic, typically PVC, polyethylene or other suitable plastics material.

The upper mold part 36 will typically have transversely movable slides associated therewith, such as is typical in molding parts of this type, which slides can be positioned for cooperation with suitable lugs or flanges provided on the molded substrate, such as along the edge or on the backside thereof, to retain the substrate within the partial mold cavity associated with the top mold part 36 when the injection mold part 48 is separated therefrom. These retractable slides also retain the substrate engaged within the upper mold part 36 throughout the remainder of the molding cycle until after creation of the intermediate foam layer 14, as described below.

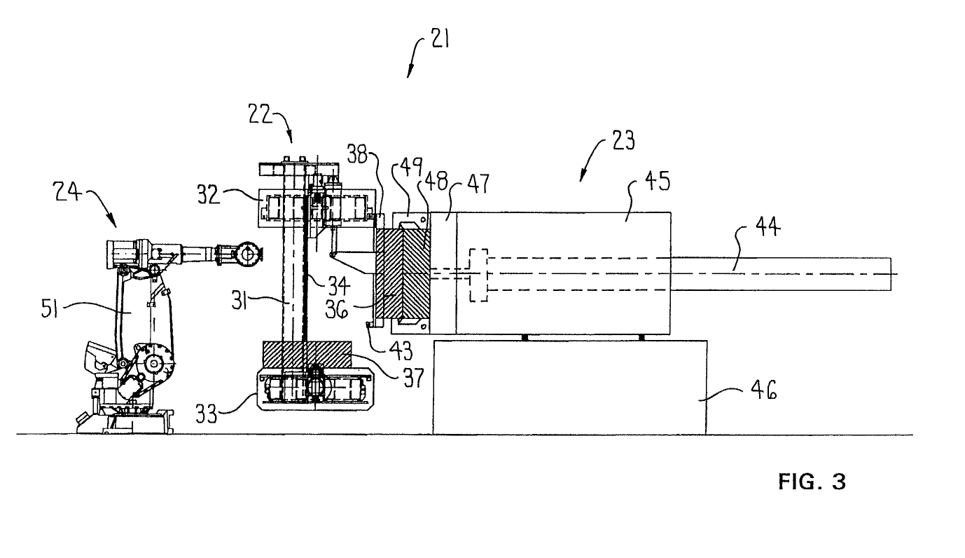

To effect forming of the thin outer skin 12, the material supply system 24 may include a conventional robot 51 positioned so as to spray a thin layer of plastics, such as urethane, into the upwardly facing mold cavity defined in the bottom mold part 37 when the main press is in the open position illustrated by FIGS. 2 and 3. The robot 51 in the diagrammatic illustration includes a first movable arm 53 which is movably connected at one end to a further arm 54, the latter being provided with a suitable urethane spray head 55 connected to a urethane spray system. The robot 51 is suitably programmed so as to move the spray head 55 in a desired pattern over the upwardly facing mold cavity defined in the bottom mold part 37 so as to spray a layer of urethane over the tool to define the thin skin 12. The mold contour defined on the upper face of the lower mold part 37 is such as to define the desired exterior configuration of the skin 12 as associated with the laminated part 11, and the mold part 37 may be heated so as to react with the sprayed polyurethane to effect solidification of the latter into a thin sheetlike skin which conforms with the shape of the upwardly facing mold contour.

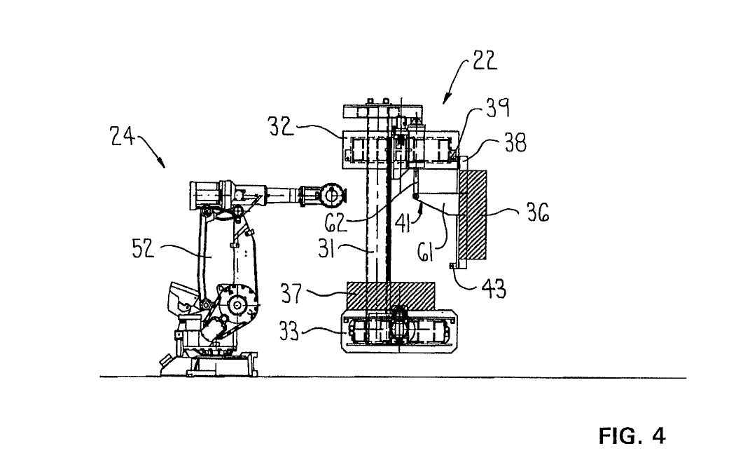

The material supply system 24 may also include a further robot 52 (FIG. 4) positioned for cooperation with the upwardly facing mold cavity defined in the open lower mold part 37, which robot 52 can have a urethane pouring system associated with the head end thereof so as to permit a predefined quantity of flowable urethane to be poured into the cavity of the lower mold part 37, which urethane is poured into the mold cavity on top of the previously-formed skin 12.

The process according to the present invention, and specifically the operation of the molding system 21 so as to effect formation of a three-layer laminated plastic part 11, will now be briefly described.

With the main molding press 22 in its open position and the injection molding apparatus 23 in its retracted position, all as illustrated in FIG. 2, and with the main molding press 22 positioned such that the upper mold part 36 is in its booked position wherein it is aligned with the opposed injection mold part 48, the injection molding apparatus 23 is activated so as to move the injection mold part 48 into closed latching engagement with the booked upper mold part 36. In this position, a suitable quantity of plastics material is injected into the mold cavity defined between the engaged mold parts 36 and 48 so as to permit formation of the substrate or backing panel 13.

While the above injection molding operation is taking place, the lower mold part 37 of the main molding press 22 is in an open, upwardly facing, horizontal position as illustrated by FIG. 3. When in this position, the robot 51 is activated so as to effect spraying of urethane over the upwardly facing mold contour defined on the lower mold part 37 so as to effect forming of the thin skin 12.

After injection molding of the substrate 13 as described above, the mold part 48 is disconnected from the upper mold part 36, and the platen carriage 45 movably retracts injection tool part 48 away from the upper tool part 36. The previously molded substrate 13 remains engaged with the mold part 36 due to the use of suitable holding devices, such as transverse slides which engage the substrate to hold it engaged with the upper mold part.

During or after the injection mold part 48 has been retracted away from the upper mold part 36, the second robot 52 pours a predefined quantity of flowable plastic, typically urethane, into the cavity of the lower mold tool 37 on top of the skin 12 previously formed threrein.

After or during the pouring of the urethane into the lower tool 36, the drive device associated with the drive screws 34 of the main molding press 23 are activated so as to initiate movement of the top tool part 36 from its booking position toward its closing position with the lower mold part 37. During this movement, the top platen 32 is moved vertically downwardly, and the linkage 41 simultaneously causes the booking plate 38 and the top tool 36 mounted thereon to swing inwardly and upwardly into latching engagement with the top platen 32, whereby the top tool 36 is now horizontally oriented and the substrate 13 as engaged with the molding face thereof is oriented downwardly toward the bottom tool 37. The top tool 36 reaches its horizontal and latched position with the top platen 32 at least a small distance before the platen 32 moves the top tool 36 into closing engagement with the bottom tool 37, at which position the tools 36 and 37 are clampingly held together in closed engagement with one another. In this closed position the substrate 13 as secured to the upper tool 36 is spaced from the skin 12 as associated with the lower tool, and flowable urethane is contained in this space and reacts in a conventional manner so as to fill the space and create the foam layer 14 which is sandwiched between and joins the skin 12 and substrate 13 together.

Under most situations the foam layer 14 when reacting between the skin 12 and substrate 13 will effectively glue or adhesively join the three layers together. If necessary, however, an appropriate adhesive may be sprayed over the exposed surfaces of either or both of the substrate 13 or skin 12, prior to pouring of the flowable urethane over the skin, so as to effect more secure adhesion of the layers together.

After the urethane has properly reacted to create the foam layer 14, then the transverse slides associated with the upper mold tool 36 are retracted so as to release the substrate 13 from the upper tool part 36. The top platen 32 is moved upwardly which in turn causes the booking plate 38 and the top mold part 36 thereon to be swung sidewardly into its booking position. The lower platen 33 can then be pivoted sidewardly if desired into an angled booking position as illustrated by FIG. 6 to facilitate removal of the three-layer laminated part 11 from the lower mold tool 37. Such removal may be accomplished either manually or by a robotic removal device.

After the laminated part 11 has been removed from the bottom tool part 37, the overall apparatus is now in a position to initiate a further cycle of operation.

With the arrangement as described above, the main molding press 22 can be stationarily positioned in close proximity to the partial injection molding press 23, whereupon the entire three-layer laminated plastic part 11 can hence be formed using only three cooperating mold halves, one of which (i.e., the upper tool part 36) cooperates with the injection tool 48 for molding the substrate, which mold part 36 also carries thereon the substrate and cooperates with the other mold part 37 on which a skin has been preformed so as to permit molding of the intermediate foam layer therebetween when engaged with this other mold part. In this manner the overall mold construction is simplified inasmuch as only three cooperating mold parts are required, rather than four mold parts when a separate two-piece injection mold is provided as is conventional. In addition, transfer of the substrate from one mold part to another is eliminated.

The efficiency of the process can be further increased by providing a plurality of main molding presses 22 which can be provided on suitable carriages, such as carriages associated with an overhead track as disclosed in aforementioned U.S. Pat. No. 6,206,676. In this manner each horizontally mobile main molding press 22 when in an open position can be moved into a position for cooperation with the injection molding apparatus 23 to permit forming of the substrate layer. After the substrate layer has been injection molded in the manner illustrated by FIG. 3 and the injection mold part 48 separated from the top mold part 36 as illustrated in FIG. 1, the main mold press 22 can then be transversely moved away from the injection press 23 so as to permit the pouring of the urethane into the bottom mold 36 and/or the closing of the main press 22 to occur at a subsquent laterally spaced workstation, whereupon a subsequent main mold press 22 can be moved into cooperative relationship with the injection molding apparatus 23 so as to permit injection molding of a further substrate. In this manner the single injection molding device 23 can be positioned for sequential cooperation with a plurality of main molding presses 22 to expedite the overall efficiency of the mass forming of laminated parts 11.

In the present invention, it is contemplated that the movement of the top booking plate 38 and the mold part 36 mounted thereon, when moving from the closed position of FIG. 5 into the booking position of FIG. 2, will result in an angular movement of the booking plate of preferably about 90°, in which position the booking plate will be vertically oriented so that the mold part 36 can thus be positioned for horizontal alignment with the opposed injection mold part 48.

While the apparatus as described above discloses forming of the skin 13 by spraying urethane over the upper surface of the lower tool part 37, it will be recognized that other conventional techniques can be utilized for forming the skin. For example, a vinyl system can be provided wherein a sheet of vinyl is fed over the upper face of the open lower tool part 37 when the latter is horizontally oriented, and the lower tool part can be provided with an appropriate conventional vacuum system so as to vacuum form the vinyl sheet over the upper tool surface to effect forming of the skin thereon.

In addition, while the above description discloses the use of separate robots 51 and 52 for spraying and pouring urethane respectively, it will be recognized that both operations can be carried out by a single robot if described. Robots and automated equipment for effecting spraying and pouring of urethane are well known, and hence further description thereof is believed unnecessary.

The injection molding apparatus 23 as briefly described herein structurally and functionally cooperates in a manner similar to that described in U.S. Pat. No. 5,417,913, the disclosure of which is incorporated herein by reference.

It will be recognized that the plastic material utilized to form the substrate 13 can be provided with fibers therein, prior to the injection process, so as to provide the substrate with the desired physical properties and/or characteristics.

While the invention as disclosed above illustrates a main molding press 22 having one structural and functional relationship for effecting movement of the upper tool part 36 between the vertical booking position, (i.e., the injection molding position) and the closed horizontal foam molding position, it will be recognized that other mechanisms can be provided so as to effect movement of the upper tool 36 between these two molding positions.

Although a particular preferred embodiment of the invention has been disclosed in detail for illustrative purposes, it will be recognized that variations or modifications of the disclosed apparatus, including the rearrangement of parts, lie within the scope of the present invention.

What is claimed is:

1. A process for molding a laminated plastic part, comprising the steps of:
providing a mold press having first and second relatively movable mold tools which are movable into an engaged closed position to define a mold cavity therebetween corresponding to the shape of the molded laminated part;
providing an injection molding apparatus having a third mold tool associated with an injection molding head and being engageable with said second molding tool to define therebetween a mold cavity corresponding to one layer of said laminated part;
moving said second mold tool into a position in spaced relationship from said third mold tools and effecting closed engagement of said second and third mold tools with one another;
injecting plastic into the mold cavity defined between the engaged second and third mold tools to define a substrate;
effecting separation between said second and third mold tools while retaining the molded substrate engaged with the second mold tool;
depositing a quantity of flowable foamable plastic into a mold cavity defined in the first mold tool;
moving the second mold tool, with the substrate engaged thereon, into closed engagement with the first mold tool containing the foamable flowable plastic therein;
maintaining the first and second mold tools closed so that the foamable plastic reacts and creates a foam layer which fills the remainder of the mold cavity with the foam layer overlying and attaching to one surface of the substrate to form a laminated part; and
opening the first and second mold tools and effecting removal of the laminated part therefrom.

2. A process according to claim 1, wherein the first mold tool is in a generally horizontal and upwardly facing orientation, wherein the third mold tool is in a vertical and generally sidewardly facing orientation, and wherein the second mold tool is moveable between a lowered position wherein it is in closed engagement with the first mold tool and a raised sidewardly oriented position wherein it is engaged with the third mold tool, with said second mold tool being vertically swingably moved through an angle of about 90° as it moves between said lowered and raised positions.

3. A process according to claim 1, including the steps of providing a plurality of mold presses each having said first and second mold tools associated therewith, and sequentially moving the individual mold presses into a position so that the second mold tool on the individual mold presses is positioned for sequential cooperation with the third mold tool as associated with the injection molding apparatus.

4. A process according to claim 1, including the step of forming a thin plastic skin over the upper face of the first mold tool prior to depositing of the flowable foamable plastic therein.

5. A process according to claim 4, wherein the thin skin is created by spraying urethane over the mold face of the first mold tool.

6. An apparatus for molding a laminated plastic part having a molded plastic backing layer laminated onto a molded foamed plastic layer, comprising:
a main molding press having first and second mold parts relatively movable into an engaged closed position wherein opposed mold faces thereon define a mold cavity corresponding to the configuration of the finished laminated part;
an injection molding arrangement positioned adjacent said main molding press and including a third mold part positioned in communication with a plastics injector, said third mold part defining thereon an exposed mold face which defines one side of a mold cavity corresponding to said substrate;
a moving support mechanism for effecting movement of said second mold part between a first position wherein it is in closed engagement with said first mold part and a second position wherein it is in closed engagement with said third mold part, said second mold part defining thereon an exposed mold face which in cooperation with the mold face on said third mold part defines the substrate mold cavity therebetween when the second and third mold parts are in closed engaged relationship; and
a plastic supply apparatus for depositing a flowable foamable plastic into the cavity defined by the mold face on said first mold part when the latter is in an open position;
whereby said substrate is injection molded between said second and third mold parts, and said second mold part with the substrate carried thereon is then moved into closed engagement with the first mold part, after the foamable flowable plastic has been deposited therein, to allow the foamable plastic to react and fill the mold cavity so as to effect formation of the laminated part between the first and second mold parts.

7. An apparatus according to claim 6, including an arrangement for effecting forming of a thin plastic skin over the mold face of the first mold part when the latter is in an open condition, and prior to deposit of the flowable foamable plastic therein.

8. An apparatus according to claim 7, wherein the first mold part is oriented generally horizontally and faces upwardly, the third mold part is oriented generally vertically and faces sidewardly, said third mold part is positioned upwardly and spaced sidewardly relative to said first mold part, and said second mold part is movable vertically upwardly and swingable vertically through an angle of about 90° as it is moved from a closed engaged position with said first mold part into a closed engaged position with said third mold part.
